(19) United States
(12) Patent Application Publication
(10) Pub. No.: US 2010/0049952 A1
(43) Pub. Date: Feb. 25, 2010

(54) MICROPROCESSOR THAT PERFORMS STORE FORWARDING BASED ON COMPARISON OF HASHED ADDRESS BITS

(75) Inventors: Colin Eddy, Round Rock, TX (US); Rodney E. Hooker, Austin, TX (US)

Correspondence Address: HUFFMAN LAW GROUP, P.C., 1900 MESA AVE., COLORADO SPRINGS, CO, 80906, US

(73) Assignee: VIA TECHNOLOGIES, INC., Taipei (TW)

(21) Appl. No.: 12/197,632

(22) Filed: Aug. 25, 2008

(51) Int. Cl. G06F 9/305

(52) U.S. Cl. 712/223; 712/E09.018

(57) ABSTRACT

An apparatus for decreasing the likelihood of incorrectly forwarding store data includes a hash generator, which hashes J address bits to K hashed bits. The J address bits are a memory address specified by a load/store instruction, where K is an integer greater than zero and J is an integer greater than K. The apparatus also includes a comparator, which outputs a first value if L address bits specified by the load instruction match L address bits specified by the store instruction and K hashed bits of the load instruction match corresponding K hashed bits of the store instruction, and otherwise to output a second value, where L is greater than zero. The apparatus also includes forwarding logic, which forwards data from the store instruction to the load instruction if the comparator outputs the first value and foregoes forwarding the data when the comparator outputs the second value.

### FIELD OF THE INVENTION

The present invention relates in general to microprocessors, and more particularly to forwarding data from an earlier store instruction to a later load instruction.

### BACKGROUND OF THE INVENTION

Programs frequently use store and load instructions. A store instruction moves data from a register of the processor to memory, and a load instruction moves data from memory to a register of the processor. Frequently microprocessors execute instruction streams where one or more store instructions precede a load instruction, where the data for the load instruction is at the same memory location as one or more of the preceding store instructions. In these cases, in order to correctly execute the program, the microprocessor must ensure that the load instruction receives the store data produced by the newest preceding store instruction. One way to accomplish correct program execution is for the load instruction to stall until the store instruction has written the data to memory (i.e., system memory or cache), and then the load instruction reads the data from memory. However, this is not a very high performance solution. Therefore, modern microprocessors transfer the store data from the pipeline stage in which the store instruction resides to the pipeline stage in which the load instruction resides as soon as the store data is available and the load instruction is ready to receive the store data. This is commonly referred to as a store forward operation or store forwarding or store-to-load forwarding.

In order to detect whether it needs to forward store data to a load instruction, the microprocessor needs to compare the load memory address with the store memory address to see whether they match. Ultimately, the microprocessor needs to compare the physical address of the load with the physical address of store. However, in order to avoid serializing the process and adding pipeline stages, modern microprocessors use virtual addresses to perform the comparison in parallel with the translation of the virtual address to the physical address. The microprocessors subsequently perform the physical address comparison to verify that the store forwarding was correct or determine the forwarding was incorrect and correct the mistake.

Furthermore, because a compare of the full virtual addresses is time consuming (as well as power and chip real estate consuming) and may affect the maximum clock frequency at which the microprocessor may operate, modern microprocessors tend to compare only a portion of the virtual address, rather than comparing the full virtual address.

An example of a microprocessor that performs store forwarding is the Intel Pentium 4 processor. According to Intel, the Pentium 4 processor compares the load address with the store address of older stores in parallel with the access of the L1 data cache by the load. Intel states that the forwarding mechanism is optimized for speed such that it has the same latency as a cache lookup, and to meet the latency requirement the processor performs the comparison operation with only a partial load and store address, rather than a full address compare. See “The Microarchitecture of the Intel Pentium 4 Processor on 90 nm Technology,” Intel Technology Journal, Vol. 8, Issue 1, Feb. 18, 2004, ISSN 1535-864X, pp 4-5. Intel states elsewhere: “If a store to an address is followed by a load from the same address, the load will not proceed until the store data is available. If a store is followed by a load and their addresses differ by a multiple of 4 Kbytes, the load stalls until the store operation completes.” See “Aliasing Cases in the Pentium M, Intel Core Solo, Intel Core Duo and Intel Core 2 Duo Processors,” Intel 64 and IA-32 Architectures Optimization Reference Manual, November 2007, Order Number: 248966-016, pp. 3-62 to 3-63. Intel provides coding rules for assembler, compiler, and user code programmers to use in order to avoid the adverse performance impact of this address aliasing case. Thus, it may be inferred that the Pentium 4 only uses address bits below and including address bit 11 in the partial address comparison.

A consequence of comparing only the particular lower address bits is that there is a noticeable likelihood that microprocessors such as the Pentium 4 will store forward incorrect data to a load instruction and it increases the likelihood the microprocessor will have to correct the mistake, which has a negative performance impact. Therefore, what is needed is a way for a microprocessor to more accurately predict whether it should store forward.

### BRIEF SUMMARY OF INVENTION

The present invention provides an apparatus for decreasing the likelihood of incorrectly forwarding data from a store instruction to a load instruction within a microprocessor, where the store instruction is older than the load instruction. The apparatus includes a hash generator, configured to perform a hashing function on J address bits to generate K hashed bits. The J address bits are bits of an address of a memory location specified by the load or the store instruction, wherein J is an integer greater than 1, wherein K is an integer greater than 0, wherein J is greater than K. The apparatus also includes a comparator, configured to output a first predetermined Boolean value if L address bits specified by the load instruction match corresponding L address bits specified by the store instruction and K hashed bits of the load instruction match corresponding K hashed bits of the store instruction, and otherwise to output a second predetermined Boolean value, wherein L is an integer greater than zero. The apparatus also includes forwarding logic, coupled to the comparison logic and configured to forward the data from the store instruction to the load instruction only if the indication indicates the first predetermined Boolean value and to forego forwarding the data from the store instruction to the load instruction when the indication indicates the second predetermined Boolean value.

In one aspect, the present invention provides an apparatus for decreasing the likelihood of incorrectly forwarding data from a store instruction to a load instruction within a microprocessor, where the store instruction is older than the load instruction. The apparatus includes a hash generator, configured to perform a hashing function on J address bits to generate K hashed bits. The J address bits are bits of an address of a memory location specified by the load or the store instruction. J is an integer greater than 1, K is an integer greater than 0, and the J address bits are virtual memory address bits. The apparatus also includes a comparator, configured to output a first predetermined Boolean value if L address bits specified by the load instruction match corresponding L address bits specified by the store instruction and K hashed bits of the load instruction match corresponding K hashed bits of the store instruction, and otherwise to output a second predetermined Boolean value. The L address bits are non-virtual memory address bits, and L is an integer greater than zero. The apparatus also includes forwarding logic, coupled to the comparator and configured to forward the data from the store instruction to the load instruction only if the indication indicates the first predetermined Boolean value and to forego forwarding the data from the store instruction to the load instruction when the indication indicates the second predetermined Boolean value.

In another aspect, the present invention provides a microprocessor. The microprocessor includes a store instruction. The store instruction includes a virtual store address and store data. The virtual store address comprises a first and a second address field. The first and second address fields include binary address bits and the first and second address fields are mutually exclusive. The microprocessor includes a load instruction. The load instruction includes a virtual load address. The virtual load address includes a third and a fourth address field. The third and fourth address fields include binary address bits and the third and fourth address fields are mutually exclusive. The microprocessor also includes a first hash bit generator configured to generate first hash bits from the second address field. Each of the first hash bits are generated by a Boolean logic circuit. At least one of the first hash bits is not identical to a bit of the second address field. The microprocessor also includes a second hash bit generator configured to generate second hash bits from the fourth address field. Each of the second hash bits are generated by a Boolean logic circuit. At least one of the second hash bits is not identical to a bit of the fourth address field. The microprocessor also includes an augmented address comparator coupled to the first and second hash bit generators, configured to generate a match signal when an augmented store address is the same as an augmented load address. The augmented store address is the concatenation of the first address field and the first hash bits and the augmented load address is the concatenation of the third address field and the second hash bits. The microprocessor also includes data forwarding logic coupled to the augmented address comparator, configured to transfer the store data from the store instruction to the load instruction when the data forwarding logic receives the match signal from the augmented address comparator.

In another aspect, the present invention provides a method for decreasing the likelihood of incorrectly forwarding data from a store instruction to a load instruction within a microprocessor, where the store instruction is older than the load instruction. The method includes hashing J address bits to generate K hashed bits by a hash generator configured to perform a hashing function. The J address bits are bits of an address of a memory location specified by the load or the store instruction. J is an integer greater than 1, K is an integer greater than 0, and J is greater than K. The method includes outputting a first predetermined Boolean value by a comparator coupled to the hash generator if L address bits specified by the load instruction match corresponding L address bits specified by the store instruction and K hashed bits of the load instruction match corresponding K hashed bits of the store instruction, and otherwise to output a second predetermined Boolean value, where L is an integer greater than zero. The method also includes forwarding the data from the store instruction to the load instruction logic by forwarding logic coupled to the comparator. The forwarding logic is configured to forward only if the indication indicates the first predetermined Boolean value and to forego forwarding the data from the store instruction to the load instruction when the indication indicates the second predetermined Boolean value.

In yet another aspect, the present invention provides a method for decreasing the likelihood of incorrectly forwarding data from a store instruction to a load instruction within a microprocessor, where the store instruction is older than the load instruction. The method includes hashing J address bits to generate K hashed bits by a hash generator configured to perform a hashing function. The J address bits are bits of an address of a memory location specified by the load or the store instruction. J is an integer greater than 1, K is an integer greater than 0, and the J address bits are virtual memory address bits. The method includes outputting a first predetermined Boolean value by a comparator if L address bits specified by the load instruction match corresponding L address bits specified by the store instruction and K hashed bits of the load instruction match corresponding K hashed bits of the store instruction, and otherwise outputting a second predetermined Boolean value. The L address bits are non-virtual memory address bits, where L is an integer greater than zero. The method includes forwarding the data from the store instruction to the load instruction by forwarding logic coupled to the comparator, only if the indication indicates the first predetermined Boolean value and to forego forwarding the data from the store instruction to the load instruction when the indication indicates the second predetermined Boolean value.

An advantage of the present invention is that it potentially reduces the number of incorrect or false store forwards the microprocessor performs. A false or incorrect store forward is a condition where store data is improperly forwarded from a store instruction to a load instruction. The store forward is incorrect because the partial address comparison indicates an address match, but the subsequent physical address comparison indicates the physical store address does not match the physical load address. Incorrect store forwards lower microprocessor performance because the load instruction must be replayed, and instructions that depend on the load instruction must be flushed from the instruction pipeline. Correcting false forwards reduces microprocessor performance by reducing instruction throughput in the instruction pipeline.

The present invention is implemented within a microprocessor device which may be used in a general purpose computer.

### BRIEF DESCRIPTION OF THE DRAWINGS

FIG. 1 is a block diagram of a microprocessor of the present invention.

FIG. 2 is a flowchart illustrating operation of the microprocessor of FIG. 1 to forward data from a store instruction to a load instruction using augmented address comparisons according to the present invention.

FIG. 3 is a flowchart illustrating steps to make choices regarding the design of hash generator and augmented address comparator of FIG. 1 according to the present invention.

### DETAILED DESCRIPTION OF THE INVENTION

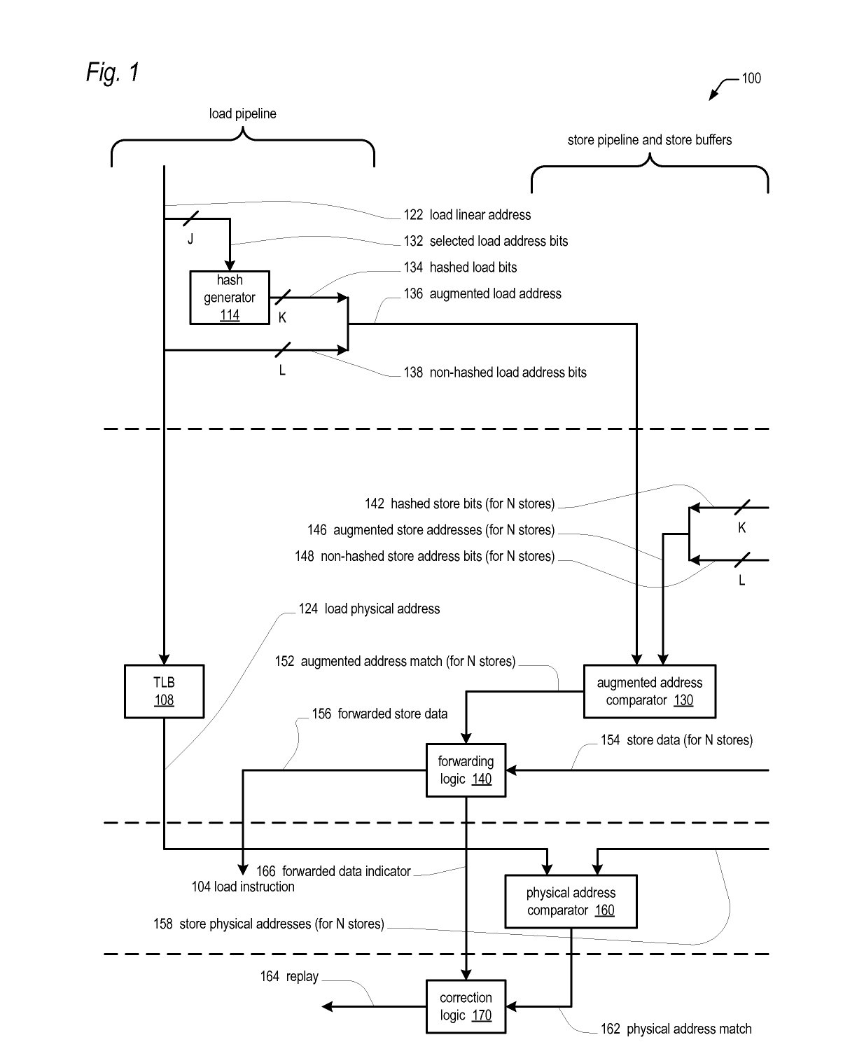

Referring now to FIG. 1, a block diagram of a microprocessor 100 of the present invention is shown. Microprocessor 100 has a load pipeline that is used to receive, execute, and retire load instructions 104. Load instructions 104 retrieve data from memory and store the data in registers of the microprocessor 100. Microprocessor 100 also has a store pipeline and store buffers. The store pipeline receives, executes, and retires store instructions. Store instructions transfer data from microprocessor 100 registers to memory. Store buffers provide temporary storage of store data and store addresses from store instructions, prior to writing the data to microprocessor 100 data cache locations. Dashed lines in FIG. 1 denote transitions from an earlier pipeline stage above the line to a later pipeline stage below the line. In FIG. 1, four pipeline stages are shown.

Load instructions 104 have a load linear address 122, which is an x86 virtual address in x86-compatible microprocessors. In one embodiment, there are 48 bits in load linear address 122. Multiple linear addresses may be mapped to the same physical address by a memory management unit of microprocessor 100. When the load linear address 122 initially enters the load pipeline of microprocessor 100, it simultaneously proceeds to three destinations. First, the load linear address 122 is provided to the microprocessor 100 cache (not shown in FIG. 1) to fetch data for the load instruction 104, if the data for the load instruction 104 is in the cache. Second, the load linear address 122 is provided to the microprocessor 100 translation lookaside buffer (TLB) 108 to obtain the load physical address 124 in the second pipeline stage, as described in more detail later. Third, the load linear address 122 is provided to the hash generator 114 in the first pipeline stage to generate hashed load bits 134 that are concatenated with a portion of the load linear address 122 to create an augmented load address 136, as described below.

In the first stage of the load pipeline of microprocessor 100, load linear address 122 is broken down into selected load address bits 132 and non-hashed load address bits 138. The non-hashed load address bits 138 are mutually exclusive of the selected load address bits 132. Selected load address bits 132 are one or more upper address bits of the load linear address 122, and there are J selected load address bits 132 shown in FIG. 1. Selected load address bits 132 are input to a hash generator 114, which converts J selected load address bits 132 into K hashed load bits 134. J is an integer greater than 1, K is an integer greater than zero, and J is greater than K. Thus, there are more J selected load address bits 132 than K hashed load bits 134. However, in another embodiment described below, J may be equal to K. There are L non-hashed load address bits 138 in FIG. 1. In one embodiment, the L non-hashed load address bits 138 are multiple consecutive lower address bits of load linear address 122. In one embodiment the selected load address bits 132 are selected from bits [47:12] of load linear address 122, and the non-hashed load address bits 138 are selected from bits [11:0] of the load linear address 122. In a virtual memory system with 4 KB pages, bits [47:12] of the load linear address 122 are virtual page address bits that the TLB 108 translates into physical page address bits and bits [11:0] of load linear address 122 are page index bits that do not require translation by the TLB 108.

Hash generator 114 transforms J selected load address bits 132 into K hashed load bits 134. The hash generator 114 performs one or more combinatorial functions—including, but not limited to, INVERT, AND, OR, XOR, NAND, NOR, and XNOR—on the selected load address bits 132. The K hashed load bits 134 and the L non-hashed load address bits 138 are concatenated to form the augmented load address 136.

Although not shown in FIG. 1, the store pipeline also includes a hash generator for generating hashed store bits 142 for each store instruction that proceeds into the store pipeline. The hash generator in the store pipeline receives J selected address bits of the store instruction linear address corresponding to the J selected load address bits 132, uses the same hash function as the load pipeline hash generator 114, and generates K hashed store bits 142 corresponding to the K hashed load bits 134. The store pipeline concatenates the K hashed store bits 142 with L non-hashed store address bits 148 corresponding to the L non-hashed load address bits 138 to form an augmented store address 146 corresponding to the augmented load address 136.

In the second store pipeline stage, an augmented address comparator 130 receives the augmented load address 136 and compares it to the augmented store addresses 146 of uncommitted store instructions in the microprocessor 100 that are older than the load instruction. An uncommitted store instruction is a store instruction that has not written its data to cache by the time the load instruction accesses the cache. FIG. 1 illustrates the augmented address comparator 130 comparing the augmented load address 136 to N augmented store addresses 146. The augmented store addresses 146 are generated in previous clock cycles for each of the N older uncommitted store instructions, some of which may reside in store buffers. Temporary storage is provided in the store pipeline for each of the N augmented store addresses 146. For each of the N augmented store addresses 146 that is identical to the augmented load address 136, the augmented address comparator 130 generates a true value on a corresponding augmented address match line 152.

Forwarding logic 140 in the second pipeline stage receives store data 154 from each of the N older uncommitted store instructions. The forwarding logic 140 also receives the N augmented address match lines 152. In response, the forwarding logic 140 selects the store data 154 of the newest uncommitted store instruction that is older than the load instruction whose corresponding augmented address match line 152 has a true value and forwards the selected data, referred to in FIG. 1 as forwarded store data 156, to the load instruction. The forwarding logic 140 also generates a forwarded data indicator 166 to correction logic 170 to indicate for which of the store instructions, if any, the forwarding logic 140 forwarded store data 156 to the load instruction.

The choice of the number of selected load address bits 132 to use, which selected load address bits 132 to use, the number of hashed load bits 134 to generate, and the hash function performed by the hash generator 114 are all design choices that may be determined through empirical testing of program streams. The choices may be affected by various factors such as the particular programs for which optimization is desired and their characteristics, which may include locality of reference, frequency and size of load and store instructions, and organization of data structures being accessed by the load and store instructions. The choices may also be affected by the particular microarchitecture of the microprocessor 100, such as number of pipeline stages, number of pending instructions the microprocessor 100 may sustain, and various instruction buffer sizes of the microprocessor 100. For example, the selected load address bits 132 may include adjacent bits and/or non-adjacent bits. However, an important factor affecting these choices is the target clock cycle of the microprocessor 100. In one embodiment, the size of the augmented load address 136 and augmented store addresses 146 are chosen such that the augmented address comparator 130 performs the comparison and the forwarding logic 140 forwards the data, if necessary, in a single clock cycle of the microprocessor 100. Another design consideration is the additional storage required to store the hashed load bits 134 and the hashed store bits 142.

In one embodiment, the hash generator 114 performs an identity function on the J selected load address bits 132 to generate the K hashed load bits 134. That is, the hash generator 114 merely passes through the J selected load address bits 132 as the K hashed load bits 134. Thus, unlike the other embodiments described above, J and K are equal and J and K are both integers greater than zero. In these embodiments, the J selected load address bits 132 include at least one of the virtual page address bits [47:12] of the load linear address 122.

In the same pipeline stage as the augmented address comparator 130 compares the augmented load address 136 to the N augmented store addresses 146, the translation lookaside buffer (TLB) 108 converts load linear address 122 into load physical address 124. Not shown in FIG. 1 is conversion of N store linear addresses into N store physical addresses 158 by TLB 108.

In the third pipeline stage of the store pipeline, a physical address comparator 160 compares the load physical address 124 to the N store physical addresses 158. For each of the N store physical addresses 158 that is identical to the load physical address 124, the physical address comparator 160 generates a true value on a corresponding physical address match line 162. The physical addresses must be compared to insure that the forwarded store data 156 is the correct data, namely that the forwarded store data 156 was forwarded from the newest store instruction whose store physical address 158 matches the load physical address 124. The forwarded store data 156 is received by the load instruction 104 in the third pipeline stage.

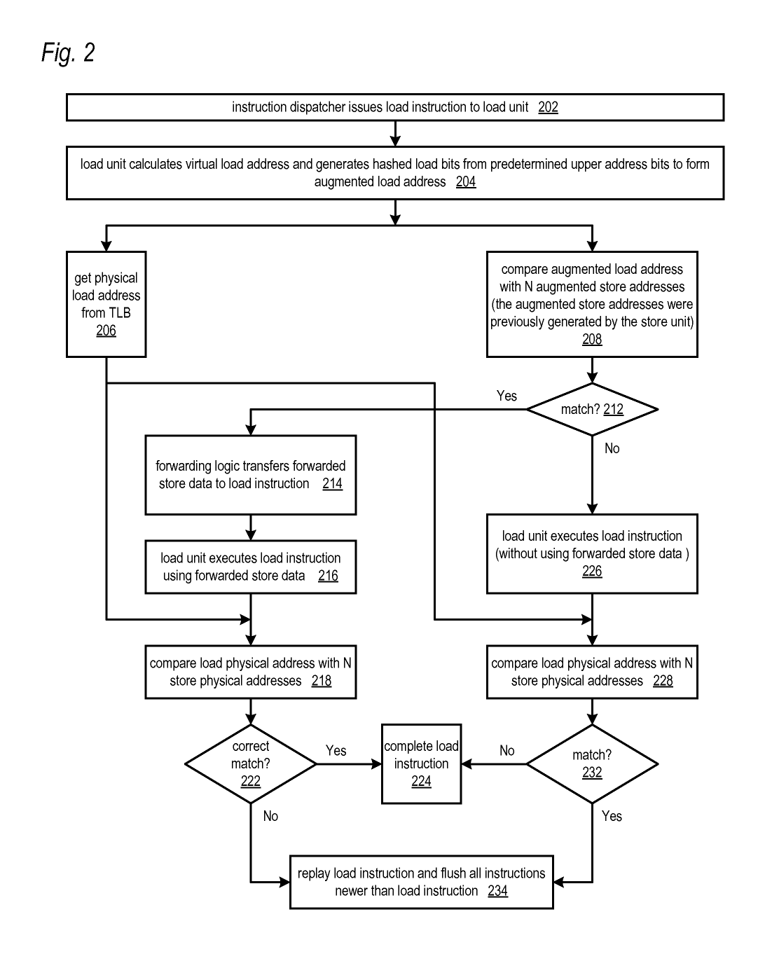

The physical address comparator 160 outputs the physical address match 162 to the correction logic 170. The correction logic 170 also receives forwarded data indicator 166 from forwarding logic 140. Based on the physical address match 162 and the forwarded data indicator 166, the correction logic 170 determines whether the forwarding logic 140 forwarded incorrect store data to the load instruction 104 (i.e., an incorrect or false store forward) or failed to forward store data to the load instruction 104 when it should have (i.e., a missed store forward). If so, the correction logic 170 generates a true value on a replay signal 164, as described below in more detail with respect to FIG. 2.

Referring now to FIG. 2, a flowchart illustrating operation of the microprocessor 100 of FIG. 1 to forward data from a store instruction to a load instruction using augmented address comparisons according to the present invention is shown. Flow begins at block 202.

At block 202, the instruction dispatcher (not shown) of the microprocessor 100 issues a load instruction 104 to the load unit pipeline. Flow proceeds to block 204.

At block 204, the load unit pipeline calculates a load linear address 122 of FIG. 1, and the hash generator 114 of FIG. 1 generates the hashed load bits 134 from the J selected load address bits 132. The hashed load bits 134 are concatenated with the L non-hashed load address bits 138 to form the augmented load address 136 of FIG. 1. Flow proceeds from block 204 to blocks 206 and 208.

At block 206, the TLB 108 of FIG. 1 receives the load linear address 122 and produces the load physical address 124 of FIG. 1. Flow proceeds from block 206 to blocks 218 and 228.

At block 208, augmented address comparator 130 compares augmented load address 136 with N augmented store addresses 146 of FIG. 1 to generate the augmented address match signals 152 of FIG. 1, where the augmented store addresses 146 were previously generated by the store unit pipeline. Flow proceeds to decision block 212.

At decision block 212, the forwarding logic 140 examines the augmented address match signals 152 generated at block 208 to determine which, if any, of the N augmented store addresses 146 matches the augmented load addresses 136. If there is at least one match, then flow proceeds to block 214; otherwise, flow proceeds to block 226.

At block 214, forwarding logic 140 of FIG. 1 forwards to the load instruction 104 store data 156 of the newest uncommitted store instruction that is older than the load instruction and whose augmented address match signal 152 was true. Flow proceeds to block 216.

At block 216, the load unit pipeline executes the load instruction 104 using forwarded store data 156 that was forwarded at block 214. Flow proceeds to block 218.

At block 218, physical address comparator 160 of FIG. 1 compares the load physical address 124 with the N store physical addresses 158 from the store unit pipeline and store buffers to generate the physical address match signals 162 of FIG. 1. Flow proceeds to decision block 222.

At decision block 222, since the forwarded data indicator 166 indicates that the forwarding logic 140 forwarded store data 156 to the load instruction at block 214, the correction logic 170 of FIG. 1 examines the physical address match signals 162 generated at block 218 to determine whether the load physical address 124 matches the store physical address 158 of the store instruction whose store data 156 was forwarded to the load instruction 104 at block 214 and whether that store instruction is the newest store instruction whose store physical address 158 matches the load physical address 124. If so, then the correct data was forwarded to and used by the load instruction 104, and flow proceeds to block 224; otherwise, incorrect data was forwarded to and used by the load instruction 104, and flow proceeds to block 234.

At block 224, the load pipeline executes the load instruction 104 and the load instruction 104 is retired. Flow ends at block 224.

At block 226, the load pipeline unit executes load instruction 104, without forwarded store data because the augmented address comparison yielded no matches at decision block 212. Instead, load instruction 104 fetches data from the microprocessor 100 cache memory or from system memory. Flow proceeds to block 228.

At block 228, physical address comparator 160 of FIG. 1 compares the load physical address 124 with the N store physical addresses 158 from the store unit pipeline and store buffers to generate the physical address match signals 162 of FIG. 1. Flow proceeds to decision block 232.

At decision block 232, since the forwarded data indicator 166 indicates that the forwarding logic 140 did not forward store data 156 to the load instruction, the correction logic 170 of FIG. 1 examines the physical address match signals 162 generated at block 228 to determine whether the load physical address 124 matches any of the N store physical addresses 158. If so, then a missed store forward occurred. That is, the load instruction 104 used stale data from memory rather than data that should have been forwarded from one of the N store instructions, and flow proceeds to block 234. However, if a missed store forward did not occur, the correct data was obtained from memory and used by the load instruction 104, and flow proceeds to block 224.

At block 234, the correction logic 170 generates a true value on the replay signal 164 which causes the instruction dispatcher to replay the load instruction 104 because the load instruction 104 used the incorrect data and to flush all instructions newer than load instruction 104. Flow ends at block 234.

As may be observed from FIGS. 1 and 2, comparing augmented load and store addresses 136/146 rather than simply some of address bits [11:0] in the store forwarding determination potentially reduces the number of incorrect store forwards that must be corrected by the microprocessor 100, which lowers microprocessor performance and reduces the value of store forwarding. However, it is noted that by using virtual page address bits—albeit hashed—in some embodiments in the store forwarding comparison determination, these embodiments potentially result in less accuracy because they introduce the possibility of virtual aliasing. That is, in a virtual memory system it is possible that multiple virtual addresses map to the same physical address. Consequently, the correction logic 170 may detect a missed store forward condition in which the augmented addresses does not match at block 212 even though the physical addresses match at block 232. However, it may be possible for some situations to select the number of hashed load bits 134 to generate, the number and which of selected load address bits 132 to use to generate the hashed load bits 134, and the hash function performed by the hash generator 114 to generate the hashed load bits 134 such that the benefit of the reduction in the number of incorrect store forwards significantly outweighs the consequences of an increase in the number of missed store forwards.

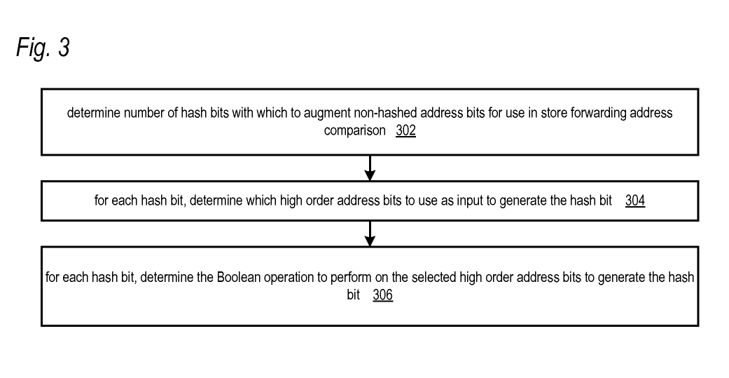

Referring now to FIG. 3, a flowchart illustrating steps to make choices regarding the design of hash generator 114 and augmented address comparator 130 of FIG. 1 according to the present invention is shown. The steps shown in FIG. 3 are performed by a microprocessor 100 manufacturer in the microprocessor 100 design and/or manufacturing stages. In one embodiment, the selection of which address bits to hash and form into the augmented addresses are also configurable during operation of the microprocessor 100 via configuration mode registers of the microprocessor 100 that may be programmed by privileged program instructions. Flow begins at block 302.

At block 302, the microprocessor 100 designer determines the number of hash bits 134 of FIG. 1 with which to augment the non-hashed address bits 138 for use in store forwarding address comparison. Flow proceeds to block 304.

At block 304, for each of the hash bits 134, the microprocessor 100 designer selects which high order address bit or bits 132 of FIG. 1 will be input to the hash generator 114 to generate the respective hash bit 134. Flow proceeds to block 306.

At block 306, for each of the hash bits 134, the microprocessor 100 designer determines the hash function the hash generator 114 will perform on the selected address bits 122 to generate the respective hash bit 134. In one embodiment, different hash functions may be performed to generate different hash bits 134. Flow ends at block 306.

As discussed above, the choice of the number of hashed load bits 134 to generate, the number and which of selected load address bits 132 to use to generate the hashed load bits 134, and the hash function performed by the hash generator 114 to generate the hashed load bits 134 are all design choices that may be determined through empirical testing of program streams and which may be affected by various factors.

While various embodiments of the present invention have been described herein, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on Chip (“SOC”), or any other device), implementations may also be embodied in software (e.g., computer readable code, program code, and instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). Embodiments of the present invention may include methods of providing a microprocessor described herein by providing software describing the design of the microprocessor and subsequently transmitting the software as a computer data signal over a communication network including the Internet and intranets. It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the herein-described exemplary embodiments, but should be defined only in accordance with the following claims and their equivalents. The present invention is implemented within a microprocessor device which may be used in a general purpose computer.

Finally, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. An apparatus for decreasing the likelihood of incorrectly forwarding data from a store instruction to a load instruction within a microprocessor, wherein the store instruction is older than the load instruction, the apparatus comprising:
a hash generator, configured to perform a hashing function on J address bits to generate K hashed bits, wherein the J address bits are bits of an address of a memory location specified by the load or the store instruction, wherein J is an integer greater than 1, wherein K is an integer greater than 0, wherein J is greater than K; and
a comparator, configured to output a first predetermined Boolean value if L address bits specified by the load instruction match corresponding L address bits specified by the store instruction and K hashed bits of the load instruction match corresponding K hashed bits of the store instruction, and otherwise to output a second predetermined Boolean value, wherein L is an integer greater than 0; and
forwarding logic, coupled to the comparator, configured to forward the data from the store instruction to the load instruction only if the comparator outputs the first predetermined Boolean value and to forego forwarding the data from the store instruction to the load instruction when the comparator outputs the second predetermined Boolean value.

2. The apparatus as recited in claim 1, wherein the hashing function comprises a Boolean function of at least two of the J address bits to generate one of the K hashed bits.

3. The apparatus as recited in claim 2, wherein the Boolean function is a Boolean exclusive-OR (XOR) function.

4. The apparatus as recited in claim 2, wherein the Boolean function is a Boolean OR function.

5. The apparatus as recited in claim 2, wherein the Boolean function is a Boolean AND function.

6. The apparatus as recited in claim 1, wherein the L address bits are exclusive of the J address bits.

7. The apparatus as recited in claim 1, further comprising:
a second comparator, configured to compare a physical memory address of the memory location specified by the load instruction with a physical memory address of the memory location specified by the store instruction; and
correction logic, coupled to the second comparator, configured to determine whether the data was incorrectly forwarded from the store instruction and to cause the load instruction to be executed with correct data if it was incorrectly forwarded.

8. An apparatus for decreasing the likelihood of incorrectly forwarding data from a store instruction to a load instruction within a microprocessor, wherein the store instruction is older than the load instruction, the apparatus comprising:
a hash generator, configured to perform a hashing function on J address bits to generate K hashed bits, wherein the J address bits are bits of an address of a memory location specified by the load or the store instruction, wherein J is an integer greater than 1, wherein K is an integer greater than 0, wherein the J address bits are virtual memory address bits; and
a comparator, configured to output a first predetermined Boolean value if L address bits specified by the load instruction match corresponding L address bits specified by the store instruction and K hashed bits of the load instruction match corresponding K hashed bits of the store instruction, and otherwise to output a second predetermined Boolean value, wherein the L address bits are non-virtual memory address bits, wherein L is an integer greater than 0; and
forwarding logic, coupled to the comparator, configured to forward the data from the store instruction to the load instruction only if the comparator outputs the first predetermined Boolean value and to forego forwarding the data from the store instruction to the load instruction when the comparator outputs the second predetermined Boolean value.

9. The apparatus as recited in claim 8, wherein J equals K.

10. The apparatus as recited in claim 9, wherein the hashing function is an identity function such that the hash generator passes the J address bits through as the corresponding K hashed bits.

11. The apparatus as recited in claim 8, wherein J is greater than K.

12. The apparatus as recited in claim 11, wherein the hashing function comprises a Boolean function of at least two of the J address bits to generate one of the K hashed bits.

13. The apparatus as recited in claim 12, wherein the Boolean function is a Boolean exclusive-OR (XOR) function.

14. The apparatus as recited in claim 12, wherein the Boolean function is a Boolean OR function.

15. The apparatus as recited in claim 12, wherein the Boolean function is a Boolean AND function.

16. The apparatus as recited in claim 8, wherein the L address bits are exclusive of the J address bits.

17. The apparatus as recited in claim 8, further comprising:
a second comparator, configured to compare a physical memory address of the memory location specified by the load instruction with a physical memory address of the memory location specified by the store instruction; and
correction logic, coupled to the second comparator, configured to determine whether the data was incorrectly forwarded from the store instruction and to cause the load instruction to be executed with correct data if it was incorrectly forwarded.

18. A method for decreasing the likelihood of incorrectly forwarding data from a store instruction to a load instruction within a microprocessor, wherein the store instruction is older than the load instruction, the method comprising:
hashing J address bits to generate K hashed bits by a hash generator configured to perform a hashing function, wherein the J address bits are bits of an address of a memory location specified by the load or the store instruction, wherein J is an integer greater than 1, wherein K is an integer greater than 0, wherein J is greater than K;
outputting a first predetermined Boolean value by a comparator coupled to the hash generator if L address bits specified by the load instruction match corresponding L address bits specified by the store instruction and K hashed bits of the load instruction match corresponding K hashed bits of the store instruction, and otherwise to output a second predetermined Boolean value, wherein L is an integer greater than 0; and
forwarding the data from the store instruction to the load instruction logic by forwarding logic coupled to the comparator, wherein the forwarding logic is configured to forward only when said outputting the first predetermined Boolean value and to forego forwarding the data from the store instruction to the load instruction when said outputting the second predetermined Boolean value.

19. The method as recited in claim 18, wherein the hashing function comprises a Boolean function of at least two of the J address bits to generate one of the K hashed bits.

20. The method as recited in claim 19, wherein the Boolean function is a Boolean exclusive-OR (XOR) function.

21. The method as recited in claim 18, wherein the L address bits are exclusive of the J address bits.

22. The method as recited in claim 18, further comprising:
comparing a physical memory address of the memory location specified by the load instruction with a physical memory address of the memory location specified by the store instruction; and
determining whether the data was incorrectly forwarded from the store instruction and causing the load instruction to be executed with correct data if it was incorrectly forwarded.

23. A method for decreasing the likelihood of incorrectly forwarding data from a store instruction to a load instruction within a microprocessor, wherein the store instruction is older than the load instruction, the method comprising:
hashing J address bits to generate K hashed bits by a hash generator configured to perform a hashing function, wherein the J address bits are bits of an address of a memory location specified by the load or the store instruction, wherein J is an integer greater than 1, wherein K is an integer greater than 0, wherein the J address bits are virtual memory address bits;
outputting a first predetermined Boolean value by a comparator if L address bits specified by the load instruction match corresponding L address bits specified by the store instruction and K hashed bits of the load instruction match corresponding K hashed bits of the store instruction, and otherwise outputting a second predetermined Boolean value, wherein the L address bits are non-virtual memory address bits, wherein L is an integer greater than 0; and
forwarding the data from the store instruction to the load instruction by forwarding logic coupled to the comparator, only if the comparator outputs the first predetermined Boolean value and to forego forwarding the data from the store instruction to the load instruction when the comparator outputs the second predetermined Boolean value.

24. The method as recited in claim 23, wherein J equals K.

25. The method as recited in claim 24, wherein the hashing function is an identity function such that the hash generator passes the J address bits through as the corresponding K hashed bits.

26. The method as recited in claim 23, wherein J is greater than K.

27. The method as recited in claim 26, wherein the hashing function comprises a Boolean function of at least two of the J address bits to generate one of the K hashed bits.

28. The method as recited in claim 27, wherein the Boolean function is a Boolean exclusive-OR (XOR) function.

29. The method as recited in claim 23, wherein the L address bits are exclusive of the J address bits.

30. The method as recited in claim 23, further comprising:
comparing a physical memory address of the memory location specified by the load instruction with a physical memory address of the memory location specified by the store instruction; and
determining whether the data was incorrectly forwarded from the store instruction and causing the load instruction to be executed with correct data if it was incorrectly forwarded.

31. A microprocessor comprising:
a store instruction comprising a linear store address and store data, wherein the linear store address comprises a first and a second address field, wherein the first and second address fields comprising binary address bits and the first and second address fields are mutually exclusive;
a load instruction, wherein the load instruction comprises a load linear address, wherein the load linear address comprises a third and a fourth address field, wherein the third and fourth address fields comprising binary address bits and the third and fourth address fields are mutually exclusive;
a first hash bit generator configured to generate first hash bits from the second address field, wherein each of the first hash bits are generated by a Boolean logic circuit, wherein at least one of the first hash bits is not identical to a bit of the second address field;
a second hash bit generator configured to generate second hash bits from the fourth address field, wherein each of the second hash bits are generated by a Boolean logic circuit, wherein at least one of the second hash bits is not identical to a bit of the fourth address field;
an augmented address comparator coupled to the first and second hash bit generators, configured to generate a match signal when an augmented store address is the same as an augmented load address, wherein the augmented store address is the concatenation of the first address field and the first hash bits and the augmented load address is the concatenation of the third address field and the second hash bits; and
data forwarding logic coupled to the augmented address comparator, configured to transfer the store data from the store instruction to the load instruction when the data forwarding logic receives the match signal from the augmented address comparator.
